(19) United States
(12) Patent Application Publication
(10) Pub. No.: US 2010/0258048 A1
(43) Pub. Date: Oct. 14, 2010

(54) Boat with battery carriers

(75) Inventor: Chia-Wen Ruan, Nantou (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: JOY RIDE TECH. CO., LTD., Nantou (TW); Chia-Wen Ruan, Nantou (TW)

(21) Appl. No.: 12/660,324

(22) Filed: Feb. 23, 2010

(30) Foreign Application Priority Data
Apr. 13, 2009 (TW) 098112168

(51) Int. Cl. B63B 17/00; B63H 21/17; B60L 11/00; B63H 1/14

(52) U.S. Cl. 114/343

(57) ABSTRACT

A boat includes a boat body and an accompanying device. The boat body includes a hull defining a first accommodation space and having left and right sides, an electric motor disposed on the hull, and a propulsion unit driven by the motor. The accompanying device includes at least one carrier assembly. The carrier assembly includes a carrier attached to either the left or right side of the hull and disposed outwardly of the hull so as to define a second accommodation space, and a battery set disposed within the second accommodation space and connected electrically to the motor for supplying electricity to the motor.

### CROSS-REFERENCE TO RELATED APPLICATION

This application claims priority of Taiwanese application No. 098112168, filed on Apr. 13, 2009.

### BACKGROUND OF THE INVENTION

1. Field of the Invention

This invention relates to a motor-driven boat, and more particularly to a boat that includes a plurality of battery carriers.

2. Description of the Related Art

Referring to FIG. 1, a conventional motor-driven boat 100 includes a plurality of batteries 11 disposed in an accommodation space 12 for supplying power. When it is desired to prolong battery life, the number of the batteries 11 must be increased. An increase in the number of the batteries 11, however, results in a reduction in both the usable space in the boat 100 and the weight-carrying capacity of the boat 100.

### SUMMARY OF THE INVENTION

The object of this invention is to provide a boat that can prolong battery life without reducing the usable space in the boat and the weight-carrying capacity of the boat.

According to this invention, there is provided a boat comprising:

a boat body including a hull defining a first accommodation space and having left and right sides, an electric motor disposed on the hull, and a propulsion unit driven by the motor; and

an accompanying device including at least one carrier assembly, the carrier assembly including a carrier attached to either the left or right side of the hull and disposed outwardly of the hull so as to define a second accommodation space, and a battery set disposed within the second accommodation space and connected electrically to the motor for supplying electricity to the motor.

Since the battery set is not disposed in the first accommodation space in the boat body, if the accompanying device includes a plurality of carrier assemblies, the battery life can be prolonged without reducing the usable space in the boat and the weight-carrying capacity of the boat.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a conventional motor-driven boat; and

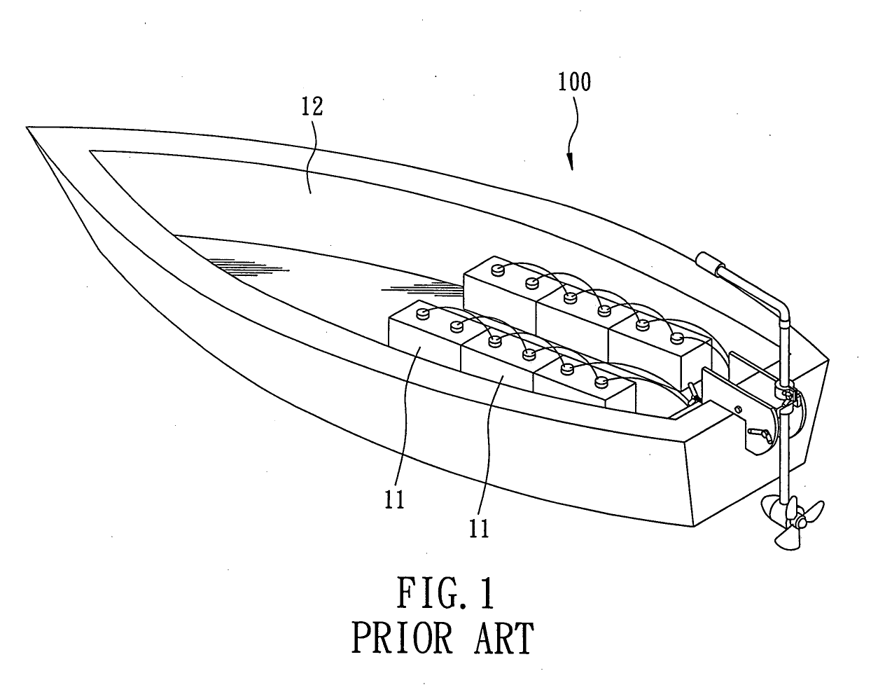

FIG. 2 is a partly exploded perspective view of the preferred embodiment of a boat according to this invention.

### DETAILED DESCRIPTION OF THE PREFERRED EMBODIMENT

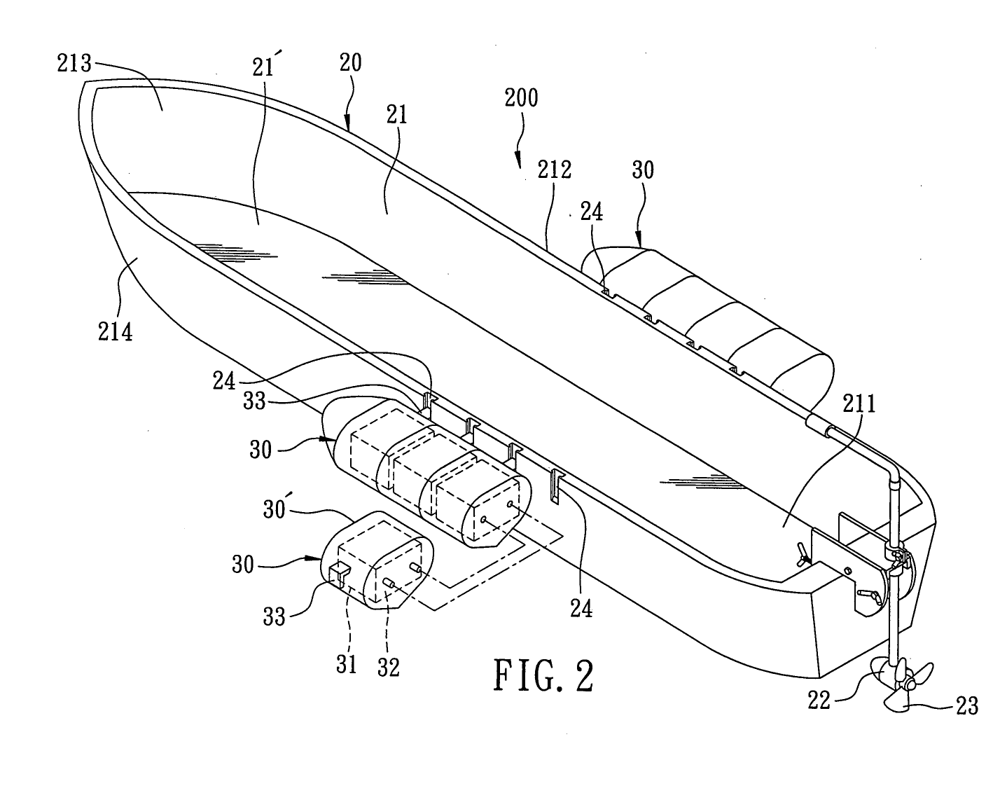

Referring to FIG. 2, the preferred embodiment of a boat 200 according to this invention includes a boat body 20 and an accompanying device consisting of two sets of carrier assemblies 30.

The boat body 20 includes a hull 21 defining a first accommodation space 21′, an electric motor 22 disposed on the hull 21, a propulsion unit 23 driven by the motor 22, and two sets of first coupling units 24 disposed respectively at left and right sides of the hull 21. In this embodiment, the propulsion unit 23 is configured as a propeller. The first accommodation space 21′ is used for receiving passengers or objects.

The two sets of carrier assemblies 30 are attached respectively to the left and right sides of the hull 21. Each of the carrier assemblies 30 includes a carrier 30′ disposed outwardly of the hull 21 and defining a second accommodation space 31, a battery set 32 disposed removably within the second accommodating space 31 and connected electrically to the motor 22 for supplying electricity to the motor 22, and a second coupling unit 33 connected removably to the corresponding first coupling unit 24 such that the carrier 30′ can be attached to the hull 21. In this embodiment, each of the first coupling units 24 is configured as a groove, and each of the second coupling units 33 is configured as a tongue. The carriers 30′ of each set of the carrier assemblies 30 are connectable with each other by tongue and groove engagement arrangements.

In this embodiment, the hull 21 includes a bottom wall 211 and a surrounding wall 212 extending upwardly from a periphery of the bottom wall 211. The surrounding wall 212 has an inner surface 213 cooperating with the bottom wall 211 to define the first accommodation space 21′, and an outer surface 214 opposite to the inner surface 213. The carrier assemblies 30 are attached to the outer surface 214 of the surrounding wall 212.

As such, the number of the battery sets 32 can be increased according to the need of the user to prolong battery life. Since the battery sets 32 are disposed outwardly of the hull 21, if the number of the carrier assemblies 30 is increased, the usable space in the boat 200 and the weight-carrying capacity of the boat 200 cannot be reduced. Thus, the object of this invention is achieved.

Alternatively, the number of the carrier assemblies 30 can be reduced to one or two. If the accompanying device includes two carrier assemblies. 30, preferably, the two carrier assemblies 30 are attached respectively to the left and right sides of the hull 21 to maintain the balance of the boat 200.

With this invention thus explained, it is apparent that numerous modifications and variations can be made without departing from the scope and spirit of this invention. It is therefore intended that this invention be limited only as indicated by the appended claims.

I claim:

1. A boat comprising:
a boat body including a hull defining a first accommodation space and having left and right sides, an electric motor disposed on said hull, and a propulsion unit driven by said motor; and
an accompanying device including at least one carrier assembly, said carrier assembly including a carrier attached to either said left or right side of said hull and disposed outwardly of said hull so as to define a second accommodation space, and a battery set disposed removably within said second accommodation space and connected electrically to said motor for supplying electricity to said motor.

2. The boat as claimed in claim 1, wherein said propulsion unit is configured as a propeller.

3. The boat as claimed in claim 1, wherein said accompanying device includes at least two said carrier assemblies attached respectively to said left and right sides of said null.

4. The boat as claimed in claim 1, wherein said accompanying device includes a plurality of said carrier assemblies, said carriers of said carrier assemblies being connectable with each other, said hull including a plurality of first coupling units, each of said carrier assemblies further including a second coupling unit, said second coupling units of said carrier assemblies being connected respectively and removably to said first coupling units.

5. The boat as claimed in claim 4, wherein each of said first coupling units is configured as a groove, and each of said second coupling units is configured as a tongue.

6. The boat as claimed in claim 1, wherein said hull includes a bottom wall and a surrounding wall extending upwardly from a periphery of said bottom wall and having an inner surface cooperating with said bottom wall to define said first accommodation space, and an outer surface opposite to said inner surface, said carrier assembly being attached to said outer surface of said surrounding wall.
